(19) United States
(12) Patent Application Publication
(10) Pub. No.: US 2010/0141649 A1
(43) Pub. Date: Jun. 10, 2010

(54) DRAWING DEVICE

(75) Inventor: Takahiro NOTSU, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/576,696

(22) Filed: Oct. 9, 2009

(30) Foreign Application Priority Data
Dec. 9, 2008 (JP) 2008-313612

(51) Int. Cl. G06T 15/00

(52) U.S. Cl. 345/419

(57) ABSTRACT

An intersection point is obtained between a triangle forming a 3-dimensional graphics and a straight line. In the straight line, a line in a triangle is obtained. Then, a pixel on the line is obtained, and only these pixels are read from memory for a drawing process. The straight line inside the triangle is determined using an edge functions.

### CROSS-REFERENCE TO RELATED APPLICATIONS

This application is based upon and claims the benefit of priority of the prior Japanese Patent Application No. 2008-313612, filed on Dec. 9, 2008, the entire contents of which are incorporated herein by reference.

### FIELD

The present invention relates to a drawing device.

### BACKGROUND

A 3-dimensional graphics drawing process refers to a process of drawing an object prepared in a 3-dimensional space on a 2-dimensional screen configured by image memory. An object to be drawn is configured by fine triangles called primitives. Therefore, the drawing process for a 3-dimensional object can be a drawing process for a number of triangles.

FIG. 7 is a block diagram of a 3-dimensional graphics drawing device.

A host processor 10 issues an object to be drawn and a draw command to a drawing device 12. Vertex/texture memory 11 stores the vertex data of the object to be drawn and texture data from the host processor. The drawing device 12 draws the data of the object to be drawn that is stored in the vertex/texture memory 11 at the instruction from the host processor 10. In this case, an already drawn image is read from image memory 13, and combines it with an image to be newly drawn. The process is used to implement an a blending process and a depth test. An α blending process is, assuming pixels A and B are of two images, and defining a as a value equal to or larger than 0 and smaller than 1, to obtain a new pixel value C=αA+(1−α)B. A depth test is to compare data indicating the depth from a screen between overlapping objects to be drawn, and determine to draw an image having data indicating a smaller depth (the object to be drawn at a smaller depth) of an object to be drawn, and not to draw an image having data indicating a larger depth (the object to be drawn at a larger depth). The image memory 13 is used by the drawing device 12 to store a drawing result. A display 14 receives an image from the image memory 13 and outputs the image to a user.

FIG. 8 illustrates a configuration of the drawing device in FIG. 7.

A vertex coordinates conversion unit 20 converts the vertex of a triangle in a 3-dimensional space into coordinates of the triangle displayed on a 2-dimensional display unit from a view point or in a projecting method. A rasterizing unit 21 draws a triangle provided by display coordinates by pixels in image memory. A rasterizing process refers to the above-mentioned process. The pixels to be drawn are ones whose centers are included in the triangle. When the drawing of the pixels is changed, the information is to be obtained about the pixels already drawn on the same coordinates, the information is combined with the pixel information about a triangle to be newly drawn, and the pixels in the image memory are updated. The relationships among the display coordinates, the pixels, and the image memory are described below. First, display coordinates refer to the coordinates on a display, and has the lower left point as an origin in implementing OpenGL. A pixel refers to a drawing unit on a display unit, is expressed by a 1×1 square area, and has the coordinates of the lower left point of the square as the coordinates of the pixel in implementing OpenGL. The coordinates of a pixel are expressed by integers for both the X and Y coordinates. The image memory stores the information about all pixels on the display.

In the description above, the definitions of a coordinate system and the coordinates of the pixels are based on the implementation of OpenGL.

The rasterizing process of a triangle can be performed using an equation called an edge function defined for each side of a triangle. The edge function of the side of a triangle is a linear equation about the display coordinates X and Y, and has the following features.
The value of the edge function is 0 on a corresponding side.
The inclination of the function faces inside the triangle (The inner of the triangle has the larger value of the edge function).

On the basis of the above-mentioned features, an inside point of a triangle constantly has three positive values of edge functions.

FIG. 9 illustrates a configuration of the conventional rasterizing unit when an image is drawn using edge functions.

A bounding box generation unit 30 generates a rectangle (bounding box) covering a triangle on the display (generates a circumscribed rectangle covering the triangle and configured by the sides only parallel to the X and Y axes). By generating the bounding box, the minimum value and the maximum value of the X and Y coordinates of the triangle can be obtained. The information about the bounding box is transmitted to a scanning coordinates generation unit 31 and a drawing unit 34.

The scanning coordinates generation unit 31 generate one by one the coordinates of the pixel in the bounding box as the coordinates of an object to be drawn according to the information about the bounding box obtained from the bounding box generation unit 30. The generated coordinates are integers for both the X and Y coordinates, and transmitted to an edge function evaluation unit 33. An edge generation unit 32 generates the edge functions of three sides from the display coordinates of a triangle. By generating the edge functions, a coefficient of each of the edge functions can be obtained. The obtained edge functions are transmitted to the edge function evaluation unit 33.

The edge function evaluation unit 33 determines whether the coordinates of an object to be drawn are located inside or outside the triangle using the coordinates of the pixels obtained from the scanning coordinates generation unit 31 and the edge functions obtained from the edge generation unit 32. If the object to be drawn is located inside the triangle, the coordinates are transmitted to the drawing unit 34. If it is located outside the triangle, no process is performed and control is passed to the operation of processing the coordinates of the next object to be drawn.

The drawing unit 34 obtains the coordinates of the object to be drawn from the edge function evaluation unit 33, and calculates the pixels of the triangle corresponding to the coordinates. Then, it obtains the existing corresponding pixels from the image memory 13, combines them with the calculated pixels, and updates the contents of the image memory 13. It takes some time to read and write data in the image memory 13. Therefore, there is a mechanism provided for obtaining, prior to the drawing, the information about the bounding box from the bounding box generation unit 30, and reading the pixels in the bounding box from the image memory 13 to the buffer 35. By providing such a pre-reading mechanism, the access time to the image memory 13 can be hidden in the arithmetic time.

By the rasterizing unit 21, a triangle can be drawn on the image memory 13. However, since all pixels in the bounding box are drawn, the following problems occur.
An edge function is calculated on the coordinates of a pixel not to be drawn.
A pixel value not to be read is read to the image memory.

FIG. 10 is an explanatory view of the conventional problems.

For example, assume a triangle 40 in FIG. 10. A bounding box 39 of the triangle 40 is illustrated in FIG. 10, and the coordinates 41, 42, and 43 of the pixels are generated by the scanning coordinates generation unit 31 in FIG. 9 and transmitted to the edge function evaluation unit 33. However, since the coordinates of the actually drawn pixel are only coordinates 43, the calculation of the edge functions of the coordinates 41 and 42 is not useful in the drawing. In addition, although the drawing unit 34 in FIG. 9 reads the contents of the bounding box to the buffer 35 prior to the drawing, the pixels in the image memory corresponding to the coordinates 41 and 42 are not used in the drawing. Accordingly, reading the pixels of the coordinates 41 and 42 is not useful in drawing an image.

### SUMMARY

The drawing device according to the present invention draws an object configured by a triangle on a screen, and includes: a span generation unit for moving a straight line parallel to an X axis or a Y axis of the screen in a direction of the Y axis if the straight line is parallel to the X axis and in a direction of the X axis if the straight line is parallel to the Y axis, and obtaining a line inside the triangle to be drawn; and a drawing unit for drawing pixels on the line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates obtaining pixels in a triangle according to an embodiment of the present invention;

FIG. 2 is a configuration of a rasterizing unit according to an embodiment of the present invention;

FIG. 3 is a flowchart of the process of calculating a span according to an embodiment of the present invention;

FIG. 4 is an explanatory view (1) of an example of an operation according to an embodiment of the present invention;

FIG. 5 is an explanatory view (2) of an example of an operation according to an embodiment of the present invention;

FIG. 6 is a flowchart of the process of the entire rasterizing process according to an embodiment of the present invention;

FIG. 7 is a configuration of a 3-dimensional graphics drawing device;

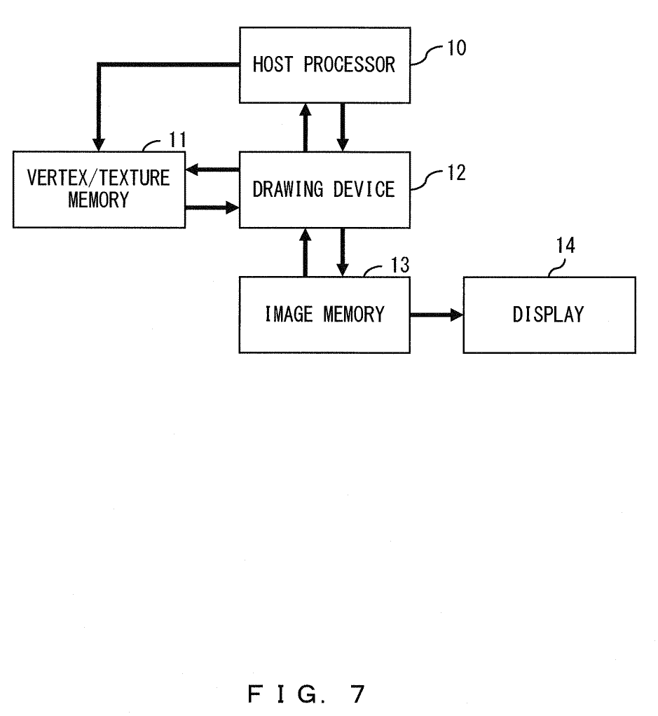

FIG. 8 is a configuration of the inside of the drawing device in FIG. 7;

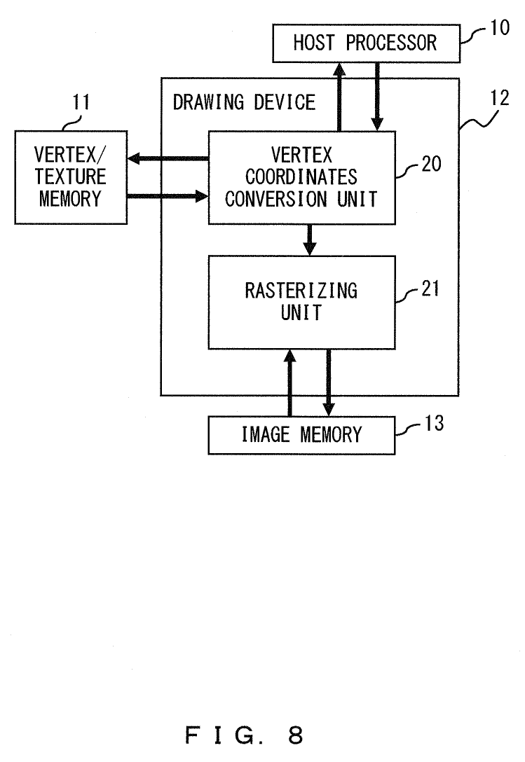

FIG. 9 is a configuration of the conventional rasterizing unit when an image is drawn using an edge function; and

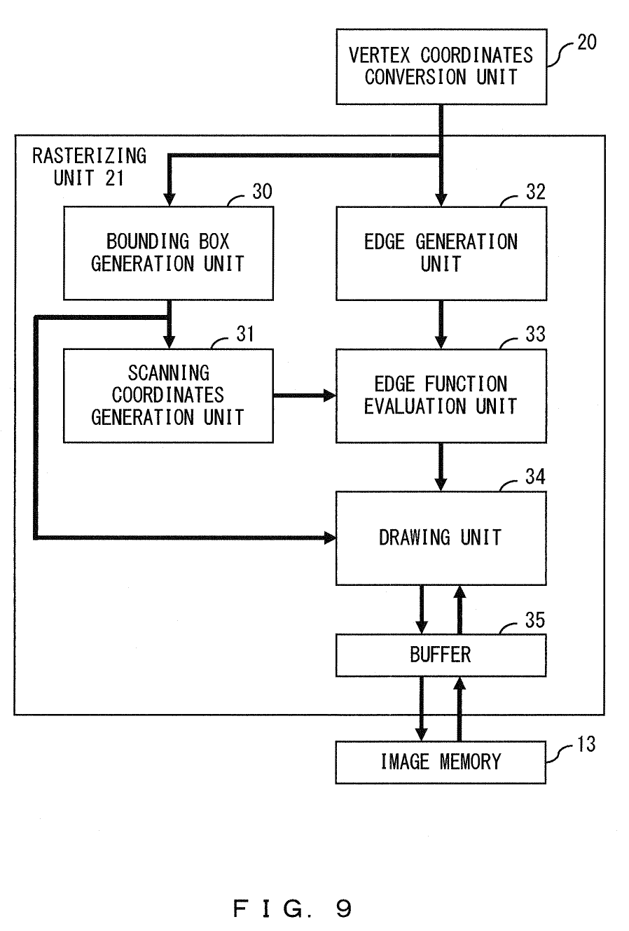

FIG. 10 is an explanatory view of the conventional problem.

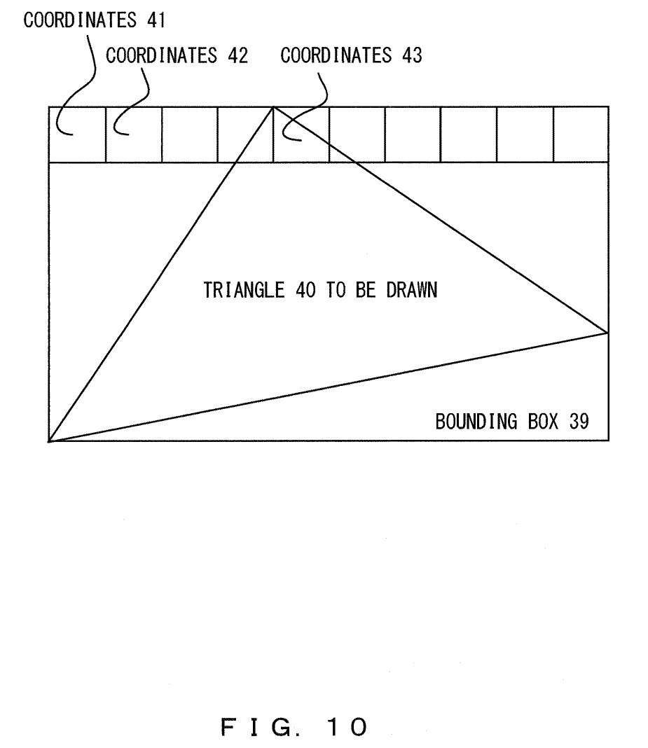

### DESCRIPTION OF EMBODIMENTS

In the embodiment of the present invention, the inclusion of coordinates is not determined with respect to a triangle by applying edge functions to each set of coordinates in a bounding box, but a plurality of straight lines having a predetermined inclination (inclination parallel to the X axis or the Y axis of the display) are prepared (or sequentially moving the straight lines), and a intersection points of each straight line and the triangle are obtained, thereby obtaining the coordinates existing in the triangle. In the following explanation, assume that these straight lines are parallel to the X axis, and the Y coordinates are half-integers. The Y coordinates are half-integers because the inclusion determination of the pixel and the triangle is made by the value of the edge function at the center point of the pixel, and the coordinates at the center point of the pixel are half-integers for both the X and Y coordinates. In the following description, the straight line parallel to the X axis is described, but by changing the X value with Y value in each equation, the following explanation is similarly applied when the straight line parallel to the Y axis is used and the X coordinates are half-integers. Therefore, in the embodiment of the present invention, not only the case in which the straight line is parallel to the X axis, but also the case in which the straight line is parallel to the Y axis is included. It is determined whether a straight line parallel to the X axis is used or a straight line parallel to the Y axis is used by, for example, configuring a bounding box of a triangle and determining a straight line parallel to the X axis if a longer side of the bounding box is parallel to the X axis, and a straight line parallel to the Y axis if a longer side of the bounding box is parallel to the Y axis.

There is a problem whether or not a pixel is included in the inside of the triangle when a pixel is located on the edge of the triangle, that is, when the edge of the triangle passes through the center of the pixel. In the following explanation, it is assumed to determine a pixel on the left edge is to be drawn, but a pixel on the right edge is not to be drawn, and a pixel on the lower edge is to be drawn, but a pixel on the upper edge is not to be drawn. In the other determining methods, that is, if it is determined that a pixel on the right edge of the triangle is to be drawn but a pixel on the left edge is not to be drawn, the present invention can also be applied.

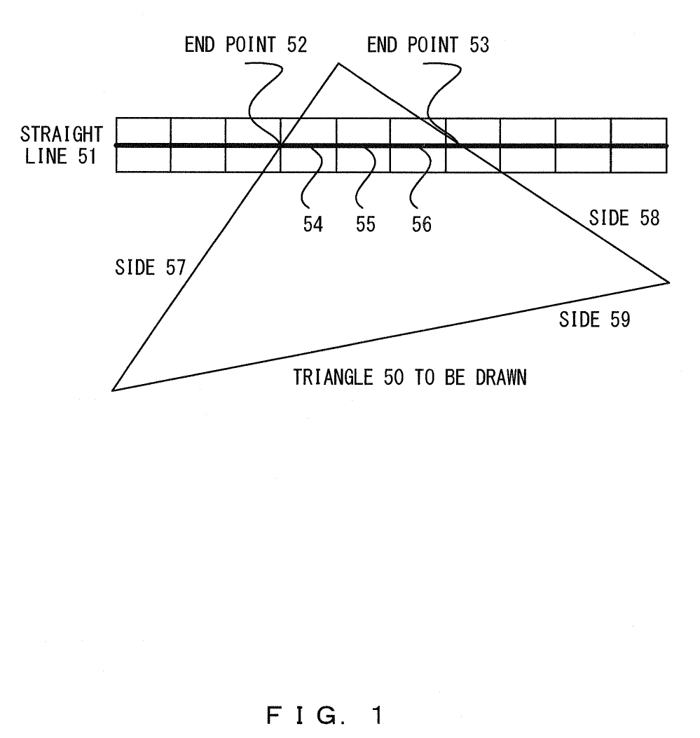

FIG. 1 illustrates acquiring a pixel inside a triangle according to an embodiment of the present invention.

First, a straight line 51 parallel to the X axis is assumed for a triangle 50 to be drawn, and intersection point 52 and intersection point 53 of the straight line 51 with sides 57 and 58 of the triangle 50 are obtained. The range from the intersection point 52 to the intersection point 53 is to be actually drawn on the straight line 51. Hereinafter, the range where the triangle exists on one straight line, that is, the range to be drawn as the triangle, is referred to as a “span”. It can be determined that pixels 54, 55, and 56 on the span of the straight line 51 are located inside the triangle, and are to be drawn. It can be determined whether or not the pixel is located on the span by determining whether or not the center position of the pixel is in the range of the span.

All pixels that are located inside the triangle and are to be drawn can be obtained by performing the above-mentioned process on all straight lines having the same inclinations.

Described below is the procedure of obtaining the span of a triangle on the straight line 51.

First, assume that the edge functions of the sides 57, 58, and 59 of the triangle 50 are f₁ (x, y), f₂ (x, y), and f₃ (x, y). Then, it can be determined that the span of the triangle on the straight line 51 has the range on the straight line 51 where edge functions f₁, f₂, and f₃ are all in the positive value, because the span of the straight line 51 is located inside the triangle and the edge functions have positive values inside the triangle.

Next, consider the range in which the edge function f₁ is positive on the straight line 51. In this case, assume that Y indicates the Y coordinate of the straight line 51, and f₁ is provided by the following equation.

f₁(x, y)=a₁x+b₁y+c₁

In addition, the x coordinates in the range to be drawn is from CXmin to CXmax. The CXmin and CXmax are technical terms called “scissor clip frame”.

To obtain the range in which the edge function f₁ is positive, three cases are assumed depending on the coefficient a of x of f₁ as positive, negative, or 0.

When a₁>0, set the value of X as follows.

X=f₁(0, Y)/a₁=−(b₁Y+c₁)/a₁
where X is an x coordinate of the intersection point of the side expressed by f₁ and the straight line 51.
When CXmax<X, it is determined that there is no drawing range.
When CXmin≦X≦CXmax, the drawing range is [X, CXmax].
When X<CXmin, the drawing range is [CXmin, CXmax].

In the case of a₁>0, since the value of f₁ increases as the value of x increases, inside the triangle x is larger than the side expressed by f₁, that is, the side expressed by f₁ can be defined as the left side of the triangle. Therefore, X indicates the coordinates of the leftmost of the span.

When a₁<0, set the value of X as follows.

X=−f₁(0, Y)/a₁=−(b₁Y+c₁)/a₁
X indicates an x coordinate of the intersection point of the side indicated by f₁ and the straight line 51.
When CXmax<X, the drawing range is [CXmin, CXmax].
When CXmin≦X≦CXmax, the drawing range is [CXmin, X].
When X<CXmin, it is described that there is no drawing range.

That is, when a₁<0, the value of f₁ becomes larger as the value of x decreases. Therefore, in the inside of a triangle, x becomes smaller than the side expressed by f₁. That is, the side expressed by f₁ can be considered a right side of the triangle. Therefore, X indicates the coordinates of the rightmost point of the span.

When a₁=0, set the value of X as follows.

X=f₁(0, Y)=b₁Y+c₁
When X≧0, the drawing range is [CXmin, CXmax].
When X<0, there is no drawing range.

In this case, the side expressed by f₁ is parallel to the X axis. Since a portion where f₁ indicates a positive value refers to the inside of the triangle, the expression of f₁(0, Y)=X≧0 holds true in the drawing range.

Similarly with f₂ and f₃, the range where the value of the function is positive can be determined. By obtaining a logical product of the range in the above-mentioned method, the span of the triangle can be obtained.

Described above is the method of obtaining a drawing range, and a more practical method of acquiring a drawing range is described below.

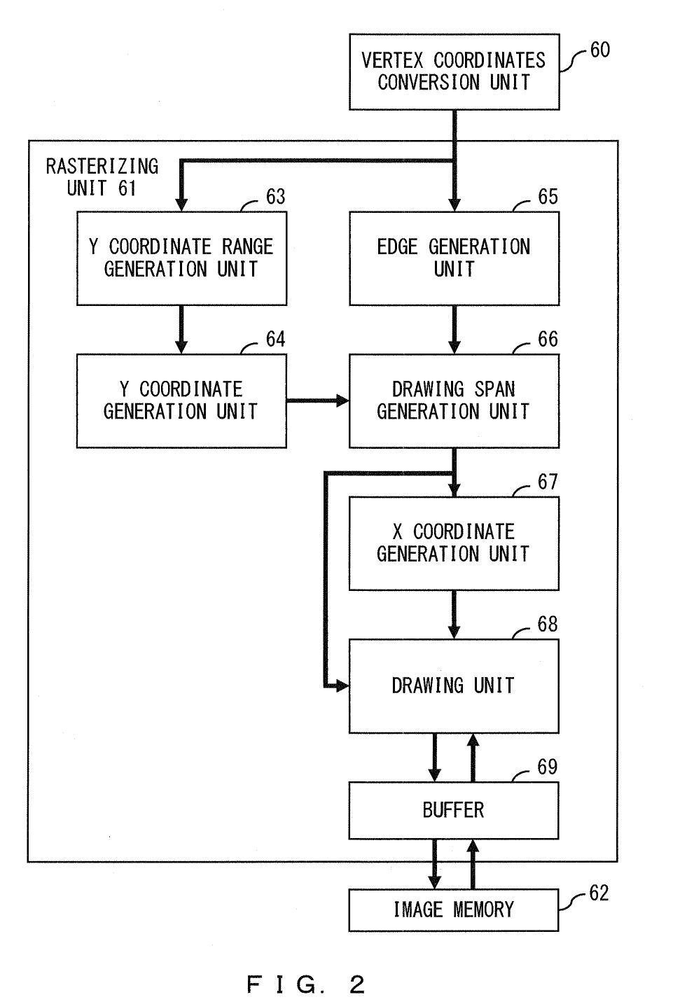

FIG. 2 is a configuration of a rasterizing unit according to an embodiment of the present invention.

A rasterizing unit 61 receives vertex coordinates after a coordinate conversion, and outputs an image as a drawing result.

A Y coordinate range generation unit 63 obtains the range of Y coordinates in which a triangle exists. The range of the Y coordinates in which the triangle exists is the range of the Y coordinates of input vertex coordinates, and obtained from the maximum value and the minimum value of the Y coordinates of the input vertex coordinates.

A Y coordinate generation unit 64 generates one by one the Y coordinate (integer) of a pixel in the range of the Y coordinates obtained from the Y coordinate range generation unit 63.

An edge generation unit 65 obtains a coefficient of an edge function from input vertex coordinates. For a simple calculation by a drawing span generation unit 66 at a later stage, the coefficient of the edge function is adjusted. The method of adjusting a coefficient is described later.

The drawing span generation unit 66 obtains the range of the X coordinate (integer) of a pixel included in the inside of the triangle on the obtained Y coordinate from the Y coordinate acquired from the Y coordinate generation unit 64 and the edge function obtained from the edge generation unit 65. The method of calculating the range of the X coordinate by the drawing span generation unit 66 is described later.

An X coordinate generation unit 67 generates one by one the X coordinate (integer) of the pixel in the range of the X coordinate obtained from the drawing span generation unit 66.

A drawing unit 68 obtains the coordinates to be drawn from the X coordinate generation unit 67, and calculates the pixel of the triangle corresponding to the coordinates. Then, it obtains a corresponding and existing pixel from image memory 62, combines the pixel with the calculated pixel, and updates the contents of the image memory. Since it takes some time to read and write data in the image memory, there is a mechanism provided for obtaining the information about a portion to be drawn from the drawing span generation unit 66 in addition to the drawing data, and reading a pixel in the range from the image memory 62 to a buffer 69. By providing a pre-reading mechanism, the access time to the image memory can be incorporated into the concurrent process.

The edge generation unit 65 calculates the coefficient of the edge function for the drawing span generation unit 66. The following calculation of a span was described above. In this process, it is assumed that Y is an integer. That is, Y is assumed to be a Y coordinate of the pixel on the straight line 51. Since the straight line 51 passes through the center of the pixel, the Y coordinate of the straight line 51 is obtained by adding the value 0.5 that is half the width of the pixel to Y as the Y coordinate of the lower left corner of the pixel.

f(0, Y+0.5)/a

or

f(0, Y+0.5)

The edge generation unit 65 changes the process on the basis of the value of a of the calculated edge function, and transmits the adjusted coefficients b′, c′, and the positive/negative/zero determination result ad of the adjusted edge function to the drawing span generation unit 66.

The coefficient of the edge function is adjusted by the following equations.

−f(0, Y+0.5)/a=−(b(Y+0.5)+c)/a=−b/a*Y−0.5*b/a−c/a=b′*Y+c′

When a>0, the following equations hold.

b′=−b/a

c′=−0.5*b/a−c/a+0.499999 . . .

ad=positive value

In this case, 0.499999 . . . is added to c′ to obtain the value of X (integer+0.999999 . . . ) when, for example, b′*Y+c′ falls on the center position (integer +0.5) of the pixel. By truncating the values of the decimal places from the obtained value, the span can be set including the pixels having pixel positions of “integers”. If b′*Y+c′ is “integer+0.51” etc. as shifted from the center of the pixel, the value of X indicates “integer+1.009999 . . . ” etc. Therefore, if the values of the decimal places are truncated to obtain the position of the pixel, “integer+1” is obtained, and the span is set so that the pixel to the right of the pixel including the edge function can be contained. As described later, if the pixel is on the left side, the pixel is selected. If it is on the right side, the pixel is not selected. The value is not limited to this example of 0.499999 . . . , but any value a little smaller than 0.5. For example, if the number of digits processed by the current arithmetic unit is four (4), then 0.499 etc. can be used. Otherwise, although there can be a slight error, 0.49 can also be used.

When the pixel on the right of the triangle is to be drawn, but the pixel on the left is not to be drawn, 0.5 is added instead of 0.4999 . . . .

When a<0, the following equations hold.

b′=−b/a

c′=−0.5*b/a−c/a+0.499999 . . .

ad=negative value

In this case, 0.499999 . . . added to c′ is equal to the value described above, and the value slightly smaller than 0.5.

When a=0, the following equations hold.

b′=b

c=c+0.5*b

ad=zero

The drawing span generation unit 66 receives the coefficients b′ and c′ of the edge function and the positive/negative/zero determination ad of the coefficient a from the edge generation unit 65, and obtains the range of the triangle on the Y coordinate specified by the Y coordinate generation unit 64 using the X coordinate. There are three values for edge functions equal to the number of sides of a triangle. In the present embodiment, the coefficients of the edge functions are combined with (b′₁, c′₁, ad₁), (b′₂, c′₂, ad₂), and (b′₃, c′₃, ad₃), and provided for the drawing span generation unit 66 in a time divisional manner.

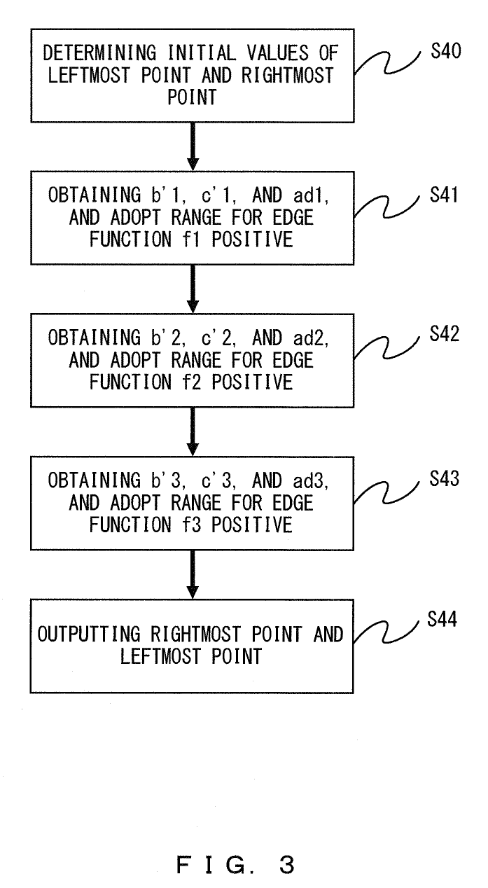

FIG. 3 is a flowchart of the process of calculating a span according to an embodiment of the present invention. In step S40 in FIG. 3, the initial values of the leftmost point and the rightmost point of a span are set. It is assumed that the initial value at an end point is in a drawable range. The drawable range of a display is provided separately in setting a drawing process.

In steps S41, S42, and S43, the range in which an edge function is positive is determined on the basis of the coefficients the edge functions f₀, f₁, and f₂ obtained from the edge generation unit 65, and reflected by the leftmost point and the rightmost point. The method of determining the range of an X coordinate for a positive edge function is described later. Reflecting the each range in which the edge function holds positive value to the leftmost point and the rightmost point results in the range (including both ends) of the X coordinates of the pixels in which three edge functions hold positive value, and the range is to be drawn. In step S44, the range is output to the X coordinate generation unit 67. If the leftmost point is larger than the rightmost point, it is assumed that there is no drawing range.

Described below is the method of determining the range of positive edge functions.
First, the following equation is assumed.
X={(b′*Y+c′) as truncated}
   When ad is a positive value,
the leftmost point of the span is to be updated. If the value of the leftmost point <X, the value of the leftmost point is updated to X. Otherwise, no operation is performed.
   When ad is a negative value,
the rightmost point of the span is to be updated. If the value of the rightmost point >X−1, the value of the rightmost point is updated to X−1. Otherwise, no operation is performed.

The value of the rightmost point is compared with X−1, but it means shifting the position of the rightmost point of the span by 1 pixel, and the pixel on the right side of the triangle is not selected. The above two cases say that the range of the span includes the pixel on the left side of the triangle and do not include the pixel on the right side of the triangle.

When ad=0 and X>0,
no operation is performed (all straight lines parallel to the X axis are to be drawn). In this case, the edge is parallel to the X axis, and the pixel is inside the triangle.
   When ad=0 and X<0,
the leftmost point=0, and the rightmost point=−1 (there is no straight line drawn parallel to the axis. That is, there is no drawing range). In this case, the edge is parallel to the X axis, and the pixel is outside the triangle.
   When ad=0, X=0, and b′>0,

No operation is performed. The edge is parallel to the X axis, the center position of the pixel is on the edge, and the triangle is above the edge. It means all straight lines parallel to the X axis are drawn.

If the pixel on the edge below the triangle is not drawn, and the pixel on the upper edge is drawn, then it is assumed that the leftmost point=0, the rightmost point=−1, and there is no drawing range.

When ad=0, X=0, and b′<0,
the leftmost point=0, and the rightmost point=−1 (meaning that there is no drawing range). The edge is parallel to the X axis, the center position of the pixel is on the edge, and there is a triangle below the edge. In this case, a straight line parallel to the X axis is not to be drawn.

The settings are performed so that no operation is performed when the pixel on the lower edge of the triangle is not to be drawn and the pixel on the upper edge is drawn, and all straight lines parallel to the X axis are to be drawn.

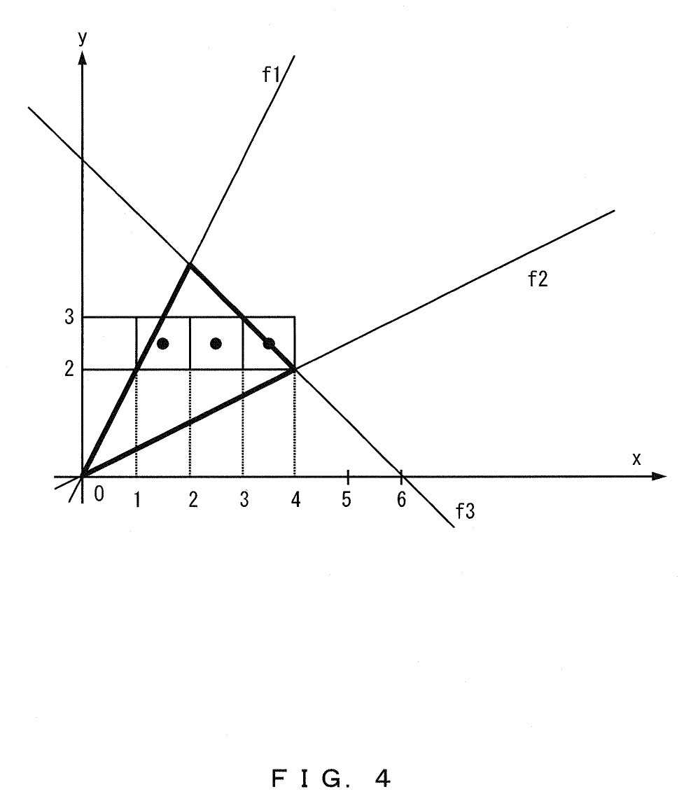

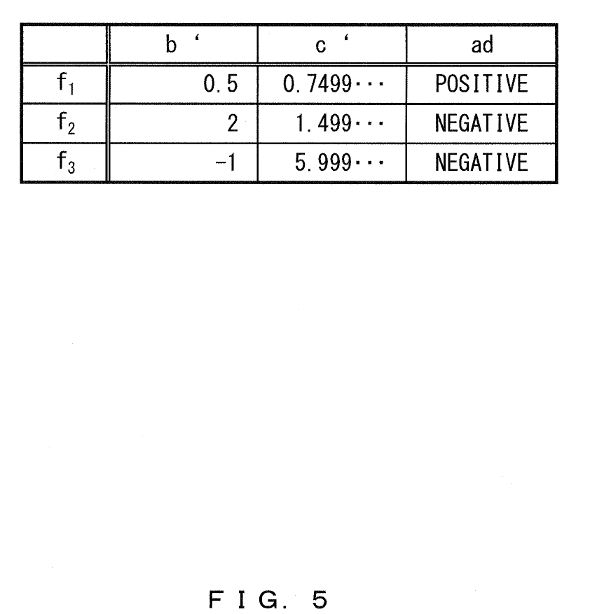

FIGS. 4 and 5 are explanatory views of examples of operations according to an embodiment of the present invention.

Described below with the reference to FIG. 4 is the case in which a span of pixels whose Y coordinate is 2 is obtained. The triangle from which the span is to be obtained is expressed as the following three edge functions. It is assumed that the drawing area of the display is [0, 6].

f₁(x, y)=2x−y

f₂(x, y)=−x+2y

f₃(x, y)=−x−y+6

Table 1 in FIG. 5 illustrates a result of adjusting the edge coefficients of f₁, f₂, and f₃ according to the above-mentioned explanation. On the basis of the coefficients obtained as described above, the following result is obtained by executing the flowchart in FIG. 3.

In step S40, the initial value of the span is set to [0, 6].

In step S41, the range of positive f₁ is determined. Since X={(0.5×2+0.74999 . . . ) as truncated}=1, and ad₁ is positive, the leftmost point is 1. Therefore, the span is [1, 6].

In step S42, the range of positive f₂ is determined. Since X={(2×2+1.499 . . . ) as truncated}=5, and ad₂ is negative, the rightmost point is 4. Therefore, the span is [1, 4].
In step S43, the range of positive f₃ is determined. Since X={(−1×2+5.999 . . . ) as truncated}=3, and ad₃ is negative, the rightmost point is 2. Therefore, the span is [1, 2].

From the result above, the X coordinate 1 and the X coordinate 2 are drawn.

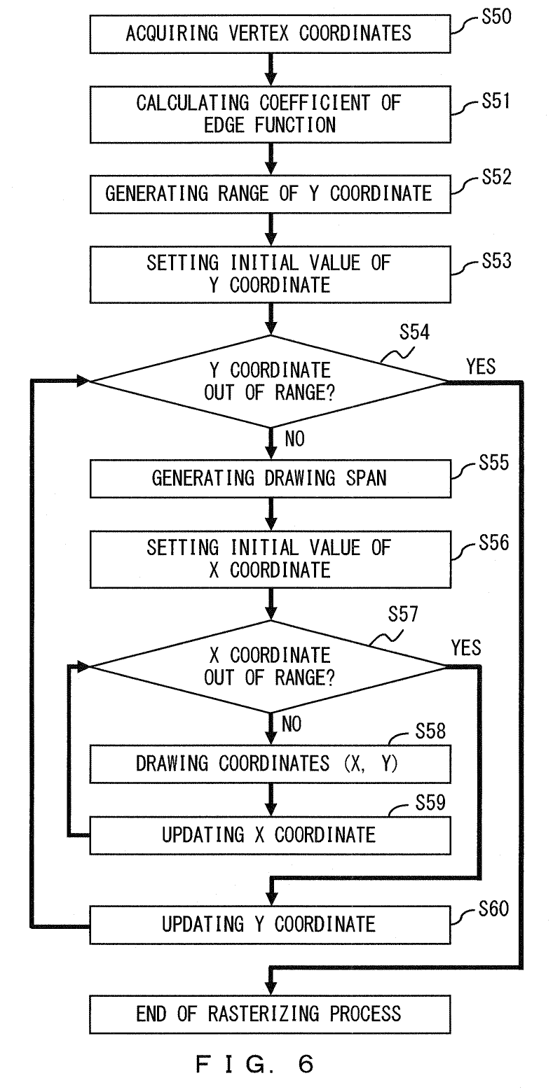

FIG. 6 is a flowchart of the process of the entire rasterizing process according to an embodiment of the present invention.

In FIG. 6, in step S50, the vertex coordinates of a triangle are obtained. In step S51, the coefficient of an edge function is calculated. In step S52, the range of the Y coordinate is generated. In step S53, the initial value of the Y coordinate is set. For example, the range of the Y coordinate is the range of the vertical side of the bounding box, and the initial value of the Y coordinate is the value of the lower end point of the range. In step S54, it is determined whether or not the Y coordinate is located outside the range. If the determination in step S54 is YES, the rasterizing process is terminated. If the determination in step S54 is NO, a drawing span is generated in step S55. The process in step S55 is the method of determining a drawing span using an edge function as described above. In step S56, the initial value of an X coordinate is set. The initial value of an X coordinate is the value of the leftmost point of the range of the drawing span. In step S67, it is determined whether or not the X coordinate is located outside the range of the span. If the determination in step S57 is YES, control is passed to step S60. If the determination in step S57 is NO, the pixel at the coordinates (X, Y) is drawn in step S58, the X coordinate is increased by 1 in the update in step S59, and control is returned to step S57. In step S60, the Y coordinate is increased by 1 in the update, and control is returned to step S54.

In the above-mentioned embodiment of the present invention, the calculation not useful in the drawing process can be suppressed, and the memory access not useful in the drawing process can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A drawing device which draws an object configured by a triangle on a screen, comprising:
a span generation unit moving a straight line parallel to an X axis or a Y axis of the screen in a direction of the Y axis if the straight line is parallel to the X axis and in a direction of the X axis if the straight line is parallel to the Y axis, and obtaining a line inside the triangle to be drawn; and
a drawing unit drawing pixels on the line.

2. The device according to claim 1, wherein
the span generation unit obtains the line using an edge function f(x, y)=a*x+b*y+c representing an inside of the triangle and defined for each side.

3. The device according to claim 2, wherein:
the span generation unit obtains a range of the line by assuming an X coordinate of a drawable range on a display as CXmin through CXmax, and Y as a Y coordinate of the straight line as follows:
when a>0,
by an equation X=−f(0, Y)/a, there is no range when CXmax<X; [X, CXmax] when CXmin≦X≦CXmax; and [CXmin, CXmax] when X<CXmin;
when a₁<0,
by an equation X=−f(0, Y)/a, [CXmin, CXmax] when CXmax<X; [CXmin, X] when CXmin≦X≦CXmax; and there is no range when X<CXmin;
when a₁=0,
by an equation X=f(0, Y)/a, [CXmin, CXmax] when X≧0; and there is no range when X<0; and
processes above are performed on three sides of the triangle, and a logical product of obtained ranges is acquired.

4. The device according to claim 1, wherein
the drawing unit draws pixels on a left side and a lower side of the triangle, but does not draw pixels on a right side and an upper side of the triangle.

5. The device according to claim 1, wherein
coordinates of the pixel are integers and coordinates of the straight line in a direction of an axis not in parallel are half-integers.

6. The device according to claim 1, wherein
a determination whether or not the pixels are to be drawn is made on a basis of center coordinates of the pixel.

7. A drawing method for drawing an object configured by a triangle on a screen, comprising:
moving a straight line parallel to an X axis or a Y axis of the screen in a direction of the Y axis if the straight line is parallel to the X axis and in a direction of the X axis if the straight line is parallel to the Y axis, and obtaining a line inside the triangle to be drawn; and
drawing pixels on the line.
